(19) United States
(12) Patent Application Publication
(10) Pub. No.: US 2012/0073343 A1
(43) Pub. Date: Mar. 29, 2012

(54) METHOD FOR PRODUCING METAL SEALING ELEMENTS

(75) Inventor: Rolf Prehn, Wipperfuerth (DE)

(73) Assignee: Federal-Mogul Sealing Systems GmbH, Herdorf (DE)

(21) Appl. No.: 13/322,128

(22) PCT Filed: May 20, 2010
(86) PCT No.: PCT/DE10/00563

§ 371 Date: Nov. 22, 2011

(30) Foreign Application Priority Data
May 22, 2009 (DE) 10 2009 022 392.4

(51) Int. Cl. B21D 11/10; B21C 37/06; B23P 13/00; B21C 37/08

(52) U.S. Cl. 72/51; 219/59.1

(57) ABSTRACT

A method for producing metallic sealing and stopper elements for flat gaskets by winding or rolling at least one metallic, sheet metal- or foil-like base body to obtain a tube as an intermediate product, bringing the mutually opposing end regions or parts, or the entire contact surface of the tube, into operative connection with each other by way of bonding, non-positive or positive joining techniques, or combinations thereof, contouring the tube or tube sections generated therefrom at least in some regions, and severing at least one annular or disk-shaped component in order to generate a sealing or stopper element in the contoured region of the tube or tube section.

### BACKGROUND OF THE INVENTION

The invention relates to a method for producing metallic sealing elements, in particular stopper elements for flat gaskets.

Annular stopper elements are presently used in production cylinder head gaskets but are, to date, die-cut from sheet metal. Given the fact that modern power units or engines place ever greater demands on sealing technology, because both combustion pressures and combustion temperatures are steadily rising, ever better technical solutions must be found to satisfy these requirements.

The costs for punched stopper rings and the connection thereof to the bearing(s) of a cylinder head gasket (for example laser welding) are significant. The use of sheet metals results in a high loss of material during die-cutting of the stopper element, and as such the material costs are also very high.

DE 197 55 391 A1 discloses a method for producing a sealing ring in which a hollow cylinder is first formed from sheet metal, with the cylinder being transformed into the shape of a reinforcement ring by a post-shaping operation and subsequently joined to a sealing lip made of polymeric material. The sheet metal is transformed into the shape of the hollow cylinder by roll-forming, incurring no waste.

U.S. Pat. No. 4,162,569 discloses a method for producing a metallic flat gasket. Either rings are cut from hollow bodies having various wall thicknesses and subjected to a specific post-shaping operation, or a flange is integrally molded on the pipe end and subsequently the pipe is cut to size. Such components can be used in the region of a cylinder head gasket as combustion chamber borders.

### SUMMARY OF THE INVENTION

It is the object of the invention to provide a method for producing metallic stopper elements, which is associated with the lowest possible material usage.

Moreover, both the sealing properties and the resilience properties are to be improved in the operational state for the stopper elements thus produced.

Finally, an option is to be provided for adjusting certain surface properties on the respective stopper element, by which better distribution of the bolt forces can be effected.

This object is achieved by a method for producing metallic sealing and stopper elements for flat gaskets by winding or rolling at least one metallic, sheet metal- or foil-like base body so as to obtain a tube as an intermediate product, bringing the mutually opposing end regions or parts, or the entire contact surface of the tube, into operative connection with each other by way of bonding, non-positive or positive joining techniques, or combinations thereof, at least partially contouring the tube or tube sections produced therefrom, and severing at least one annular or disk-shaped component so as to generate a sealing or stopper element in the contoured region of the tube or tube section.

The following materials can be used as the base body:
an individual strip of sheet metal or foil, which has the same material thickness throughout, or into which depressions or elevations have been introduced in some regions, for example by means of rolling
a plurality of strips of sheet metal or foil disposed next to and/or on top of each other, wherein similar or dissimilar sheet metal strips or foil strips can be used, which additionally have different material properties and/or material thicknesses
generating expanded metal by introducing incisions at least in some regions in the longitudinal and/or transverse directions of a metallic base body and appropriately expanding the base body in the longitudinal and/or transverse directions
generating a base body from sections of expanded metal and sections of a sheet metal strip or foil strip disposed next to and/or on top of each other.

One or more sheet metal strips or foil strips can be cut out by means of laser cutting, fine blanking or similar methods. The essential aspect here is that the edges, which are subsequently joined, in particular welded, to each other, are free of burrs. It may be helpful in some instances not to weld end regions that are rectilinear to each other, but to employ a zigzag or wave contour so as to achieve better joining and additionally provide the subsequent weld seam with further properties (for example, a certain rigidity or the like).

The base body formed by an individual sheet metal strip or foil strip, or the aforementioned elements, is subsequently formed, wound or rolled to obtain a tube and, as was already mentioned, brought into operative connection at the mutually opposing end regions, as seen looking along the entire sheet metal width.

A variant of rolling or winding a substantially endless metal sheet to obtain a tube is likewise conceivable, wherein the connection can then be effected not only at the end regions, but simultaneously, or alternatively, at least in some regions at the contact surfaces of the winding regions located on top of each other.

Such a tube is relatively easy to handle and can be fed to a contouring or shape-forming process. To this end, it is conceivable to roll or stamp the desired shape (for example an L profile) into the tube using rollers or a sort of die. This can be done either at one end of the tube, so as to produce individual rings/disks, or over the entire length of the tube, so as to allow a plurality of rings to be severed simultaneously. For this purpose, the contouring process can be carried out in one step or in several steps.

The respectively contoured region of the tube can subsequently be cut open or die-cut so as to generate rings or disks in order to obtain individual or multiple of metallic sealing elements. A punching process, fine blanking or, for example, a kind of roller cutting, laser cutting, water jet cutting or the like, is suited for this purpose. This produces virtually no material loss.

Moreover, it is possible to cut the prefabricated tube into tube sections and to form these into disks, for example by means of a press.

Such a stopper element, or such a pipe section, is relatively easy to handle and can be fed to a flanging process, for example when the ring has an L shape.

Compared to a stamped stopper, this variant has the advantages of the previously known weld stopper (Laspot). The operating principle is simple. When installed in the cylinder head gasket, the bolt force that is introduced is distributed to defined surface areas. Compared to stamping tools (notably topography), the tooling is very simple.

The connection, or the integration of the respective stopper element in a gasket or a sealing system, can be effected by bonding, positive or non-positive methods, or combinations thereof.

Welding methods, for example laser welding or resistance welding, are excellently suited if small elevations (protrusions) are to be embossed while die-cutting the ring/the disks, so as to produce a clearly defined contact surface for the resistance welding operation. Moreover, the connection to a layer of a cylinder head gasket may be done by simple flanging. It is likewise conceivable to emboss a small depression or a protuberance in a spacer layer of the cylinder head gasket, so that the position of the stopper is defined for subsequently gluing or welding the stopper element in this depression or protuberance.

The subject matter of the invention is shown in the drawings based on an exemplary embodiment and is described as follows. In the drawings:

### BRIEF DESCRIPTION OF THE DRAWINGS

FIGS. 1 to 8 are schematic diagrams of primary products having various designs for generating wound or rolled tubes;

FIGS. 9 and 10 are schematic diagrams of working steps for contouring tubes;

FIGS. 11 to 13 show schematic diagrams for working a tube so as to produce individual annular sealing elements therefrom;

FIGS. 14 to 17 show annular or disk-shaped sealing elements having various designs;

FIG. 18 is a schematic diagram of a cylinder head gasket, containing one of the sealing elements according to FIGS. 14 to 17; and

FIGS. 19 and 20 show alternative methods for producing sealing elements.

### DETAILED DESCRIPTION OF THE INVENTION

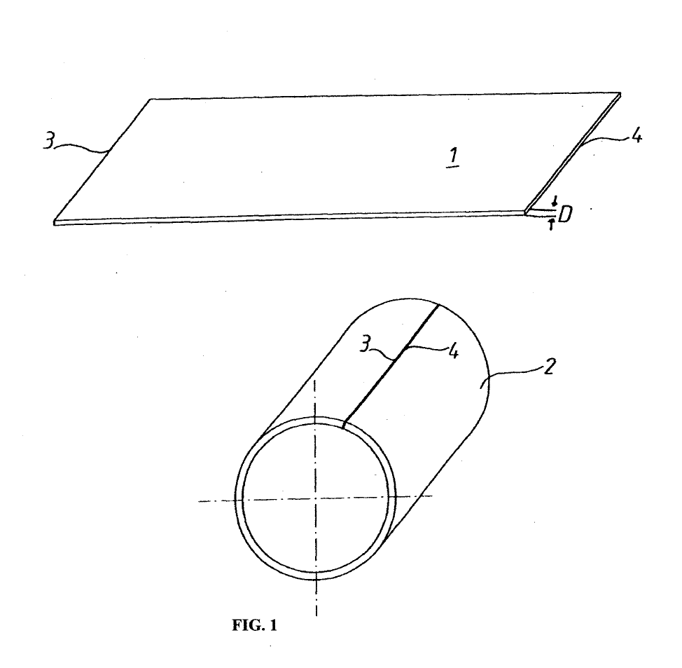

FIG. 1 shows a sheet metal strip 1 having a predefinable material thickness D 1, which can comprise a wide variety of metal alloys, depending on the respective application of the sealing element to be produced therefrom. As seen looking over the extension, the sheet metal strip 1 has the same material thickness D. As is apparent in the lower image in FIG. 1, the sheet metal strip 1 is wound or rolled to obtain a tube 2, wherein the end regions 3, 4 of the sheet metal strip 1 in this example are welded together. If necessary, different contours (not rectilinear) can also be provided so as to adjust additional properties on the weld seam. With this measure, a tube 2 having a defined diameter is obtained. Further tubes comprising the same or different materials having smaller or larger diameters can be generated, which are then brought into operative connection with the tube 2 by pushing them inside one another.

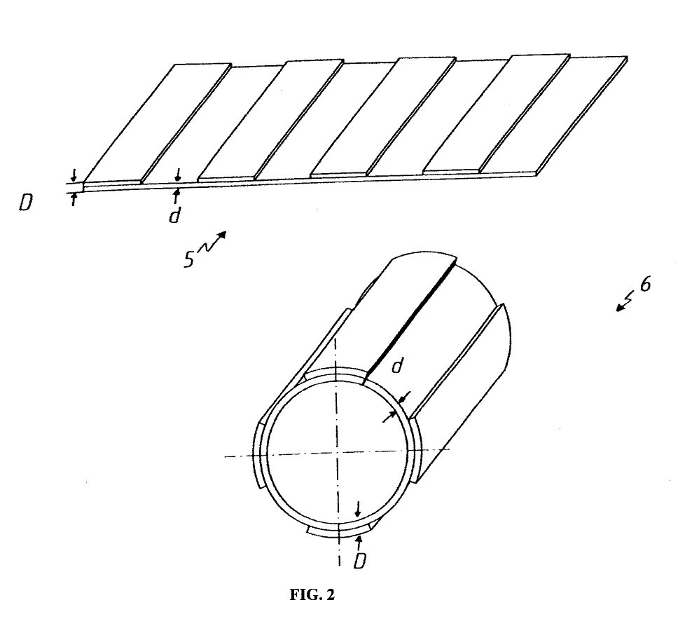

FIG. 2 shows an alternative sheet metal strip 5, which likewise has a material thickness D. So as to generate various material thicknesses (ratio D/d), the sheet metal strip 5 is subjected to at least one rolling operation, whereby the original material thickness (D) is reduced. This sheet metal strip 5 is then rolled or wound, whereby a tube 6 is generated, which, as seen looking in the circumferential directions, comprises regions having a lesser material thickness d and regions having a greater material thickness D.

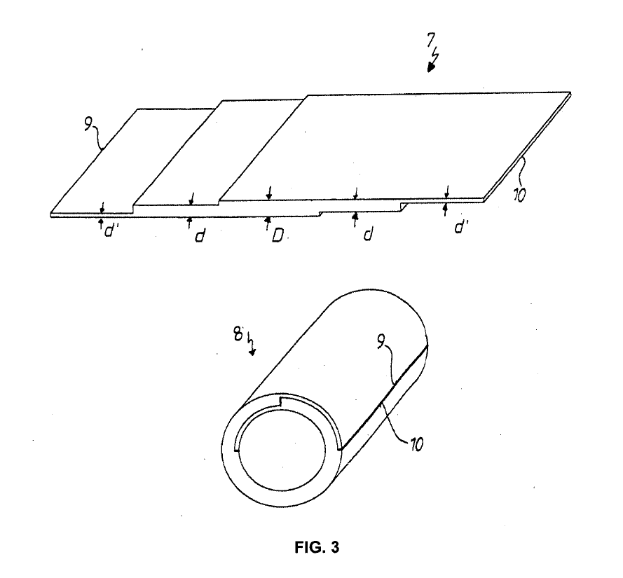

FIG. 3 shows another embodiment. A sheet metal strip 7 having a base material thickness D is subjected to a rolling operation, similar to that described for FIG. 2, whereby reduced material thicknesses d′, d′ are obtained. As described already for the other figures, the sheet metal strip 7 is shaped by rolling or winding to obtain a tube 8, wherein the end regions 9, 10 are located inside one another after the forming/rolling/winding operation so as to obtain a uniform outside diameter. Analogously to FIGS. 1 and 2, the end regions 9, 10 are joined by welding.

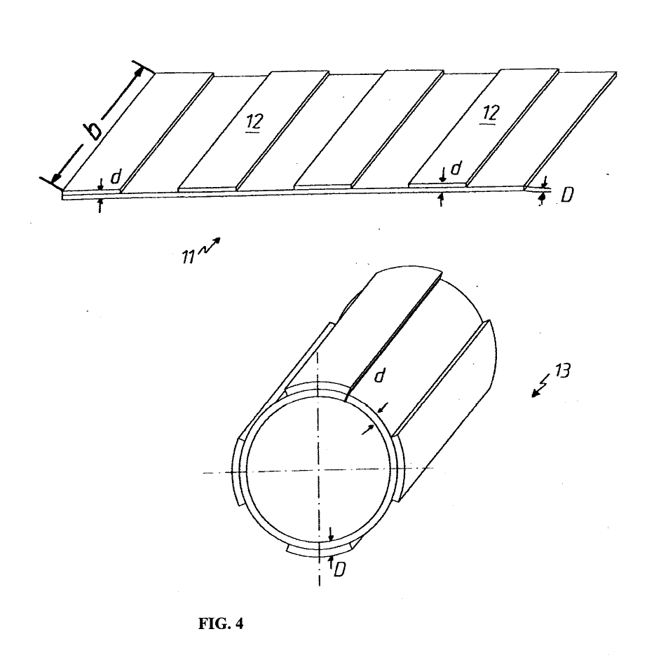

FIG. 4 shows a further alternative for generating a sheet metal strip. Sheet metal sections 12, having a predefinable material thickness d and width b, are placed onto a base sheet metal 11, having a predefinable material thickness D, in defined positions (at least one) and connected to the base sheet metal 11 by bonding or non-positively or positively, or by combinations thereof. Similarly, as described above, the sheet metal strip 11 is formed so that, as seen looking in the circumferential direction of the generated tube 13, sections having a lesser material thickness d and sections having a greater material thickness D are obtained.

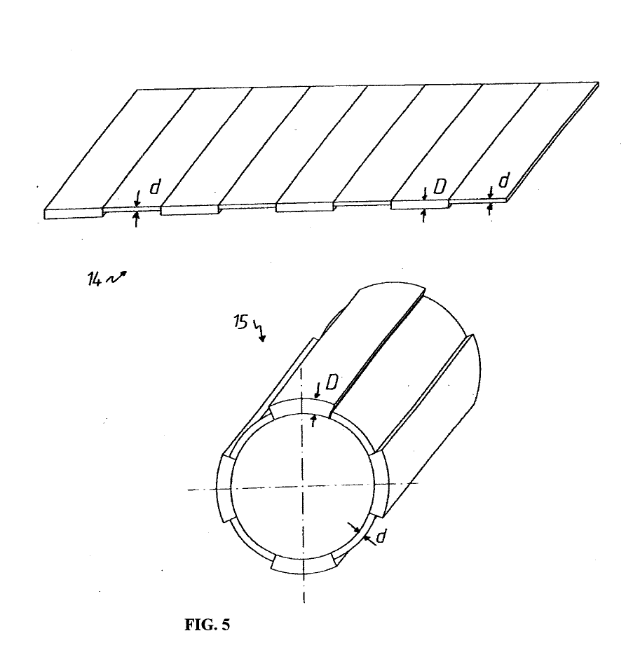

In FIG. 5, sheet metal strips 14 having various widths and thicknesses D, d are combined with each other in defined positions. Known bonding, non-positive or positive methods, or combinations thereof, are employed. This tailored blank is formed to obtain a tube 15, wherein, as seen looking in the circumferential direction, sections having a greater material thickness D and sections have a lesser material thickness d are obtained.

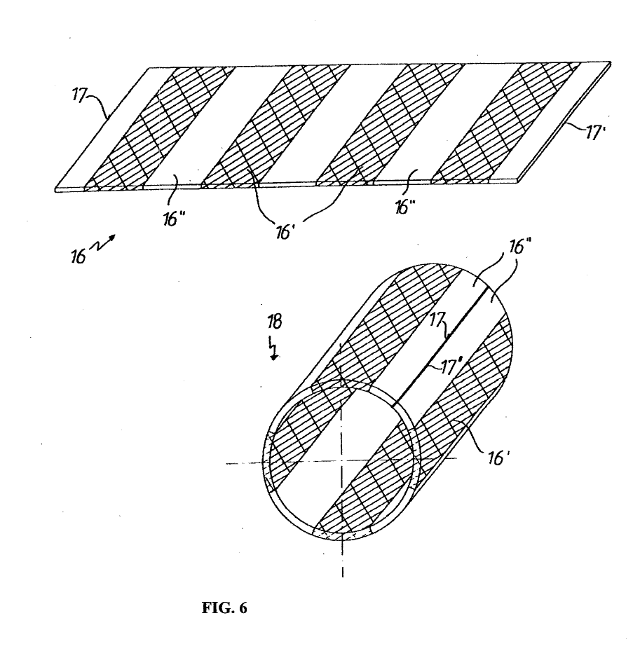

FIG. 6 shows a further alternative base body 16. The same comprises regions made of expanded metal 16′, which are obtained by longitudinal and/or transverse incising in the base body 16 with subsequent expansion in the longitudinal and/or transverse directions. Analogously to the preceding figures, the sheet metal strip 16 is formed, or milled or rolled, to obtain a tube 18, so that, as seen looking in the circumferential direction, sections comprising expanded metal 16′ and sections 16″ comprising the sheet metal base body 16 are obtained. Again, the end regions 17, 17′ of the sheet metal strip 16 are joined to each other, for example by welding.

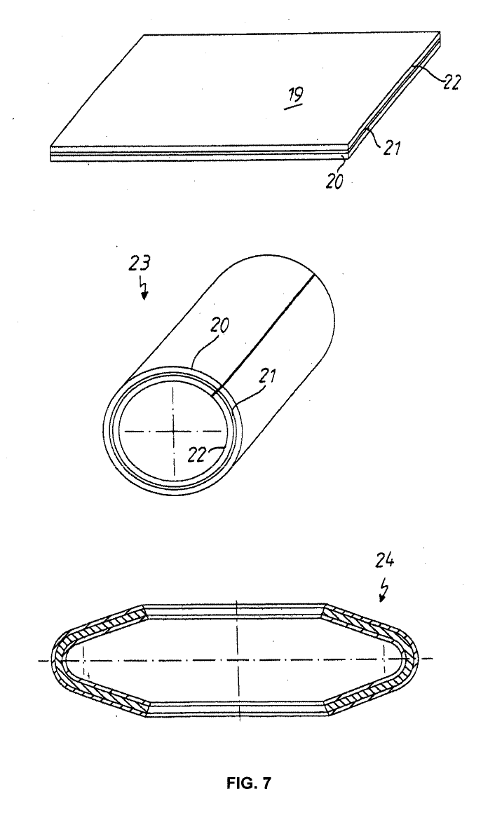

FIG. 7 shows an alternative sheet metal strip 19, which is composed of three layers 20, 21, 22, optionally having different thicknesses and optionally comprising different materials (for example composite materials). The sheet metal strip 19 is formed so as to obtain a tube 23, as previously described. A sealing element 24, which is generated from a likewise three-layered sheet metal strip (not shown), is shown in the lower image of FIG. 7.

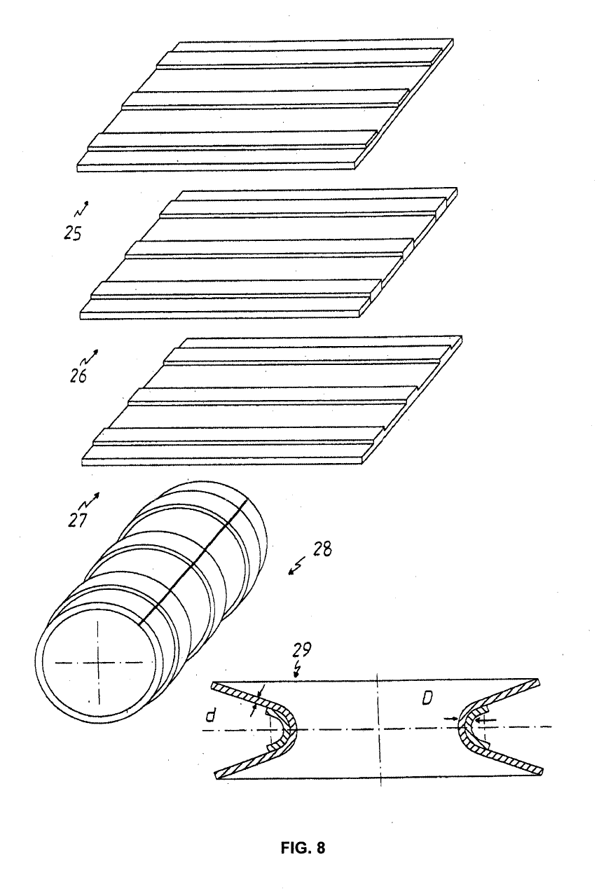

FIG. 8 shows further sheet metal strips 25, 26, 27 having alternative designs, which are formed to obtain a tube 28. A sealing element 29 produced from one of these sheet metal strips 27 to 27, or produced from the tube 28, comprises regions having a greater material thickness D and regions have a lesser material thickness d.

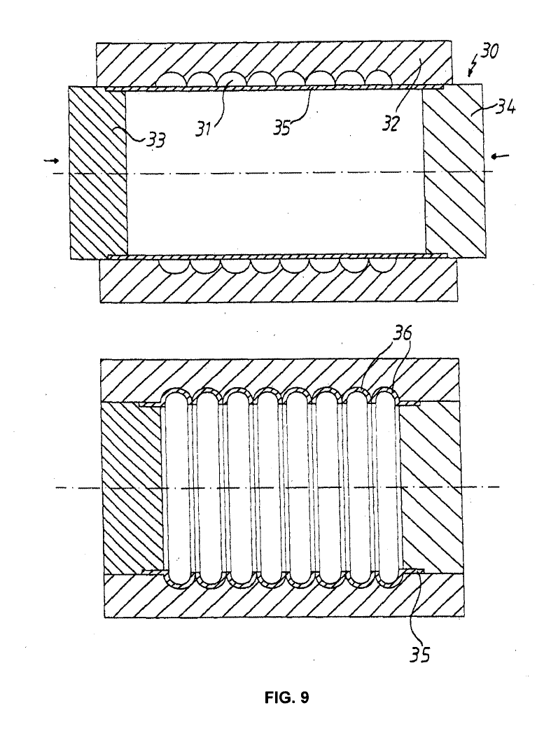

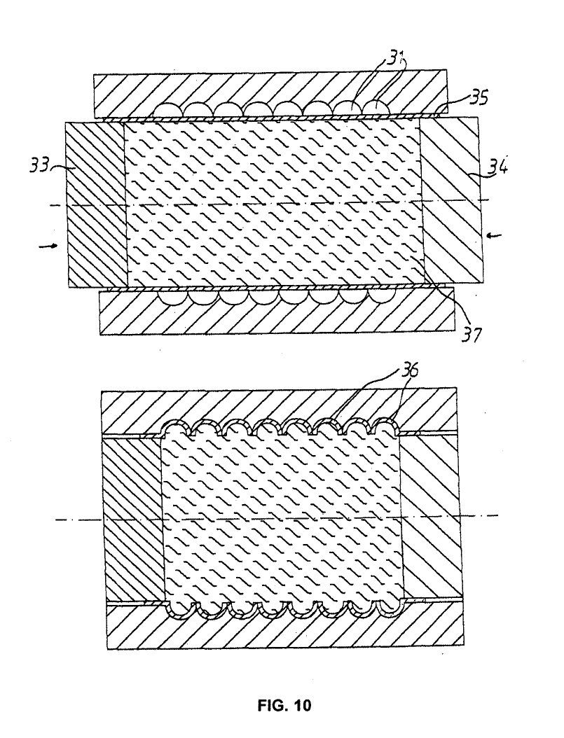

FIGS. 9 and 10 show possible working steps for contouring tubes.

FIG. 9 shows a tool 30, containing a base body 32 (not shown) that is provided with recesses 31 and has at least two parts, and dies 33, 34, which can be moved in the directions of the arrows. Given the multi-part design of the base body 32, the formed tubes 35 can later be removed without difficulty. A tube 35, which can be composed of one of the primary products shown in FIGS. 1 to 8 (shown here in simplified form), is moved to the region of the base body 32. By applying a force to the dies 33, 34 (directions of the arrows) and optionally an internal pressure (for example by an active medium, such as water or oil), the wall of the tube 35 is pressed into the recesses 31, whereby defined contours 36 are obtained. The tube 35 thus contoured can be divided into individual rings using suitable working tools, with the rings then being subjected, as needed, to a further shape-forming process so as to generate a finished sealing ring.

FIG. 10 shows an alternative shape-forming method, which is to say the rubber pad forming method. A rubber body 37 is positioned between the dies 33, 34. By applying pressure to the rubber body 37 with the dies 33, 34, the tube 35 is pressed into the recesses 31, whereby analogously to FIG. 9, the contours 36 are obtained.

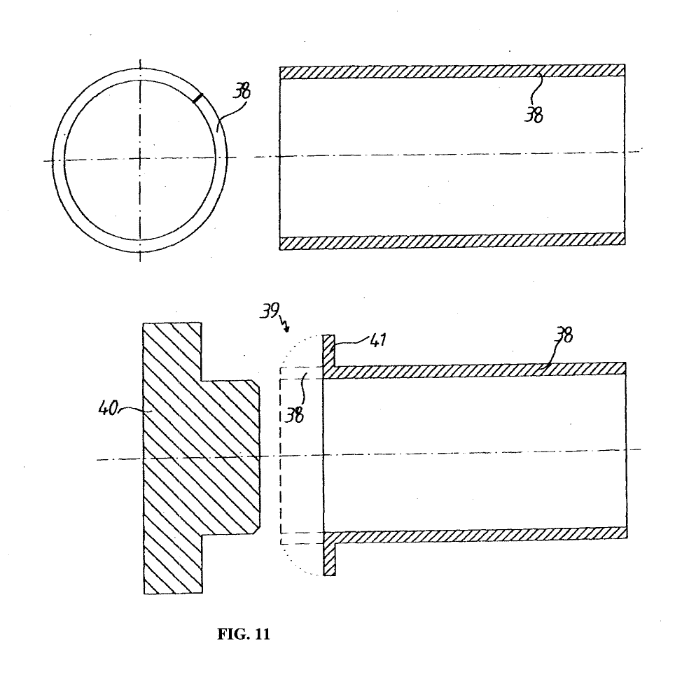

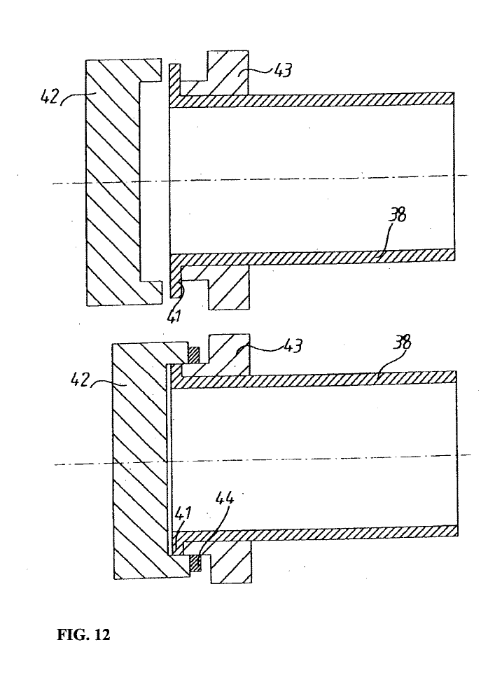

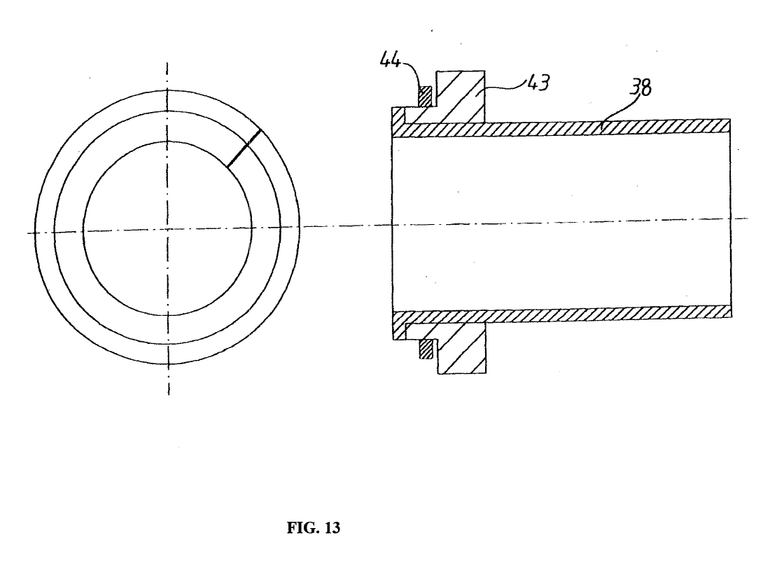

FIGS. 11 to 13 show schematic diagrams of a sequence of working steps for generating disk-shaped stopper elements. A tube 38 (shown in simplified form) is apparent, which can be obtained from a primary product according to FIGS. 1 to 8. In the region of one of the tube ends 39, a radial shoulder 41 is integrally molded on the tube 38 by means of a die 40. After the shoulder 41 has been integrally molded on, rings 44 are cut from the radial shoulder 41 by additional suitable tools 42, 43.

It is also conceivable to carry out this process on tube sections.

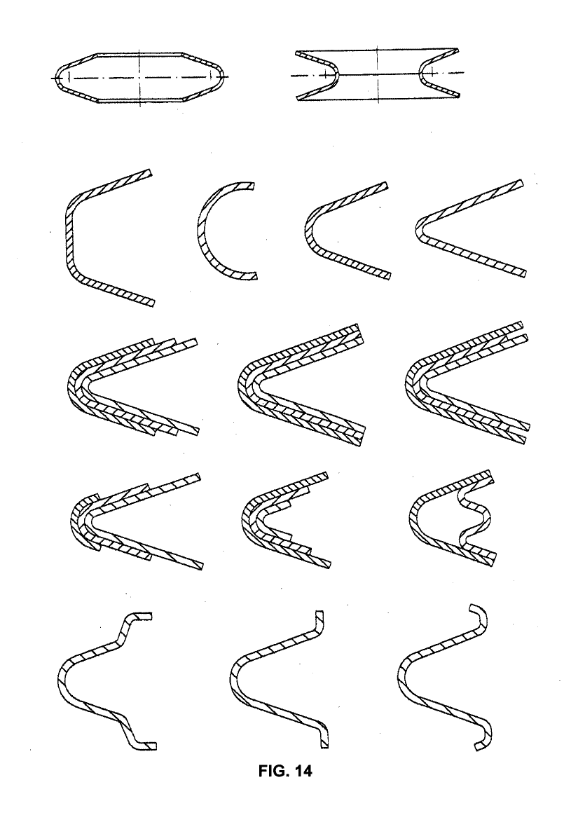

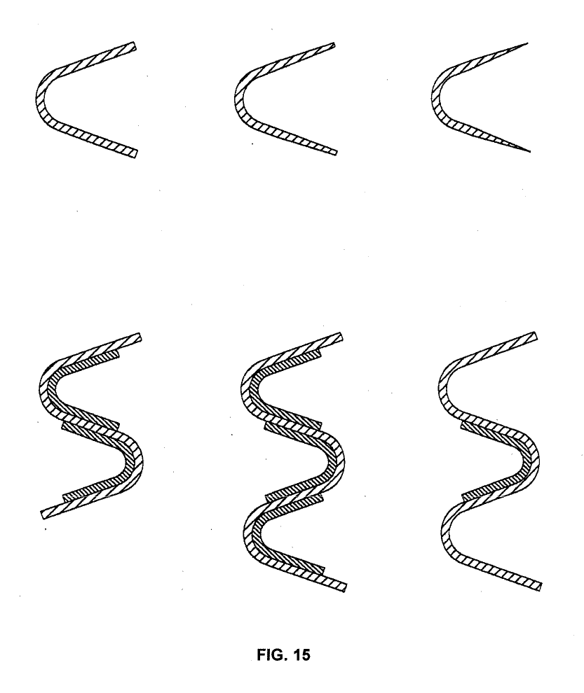

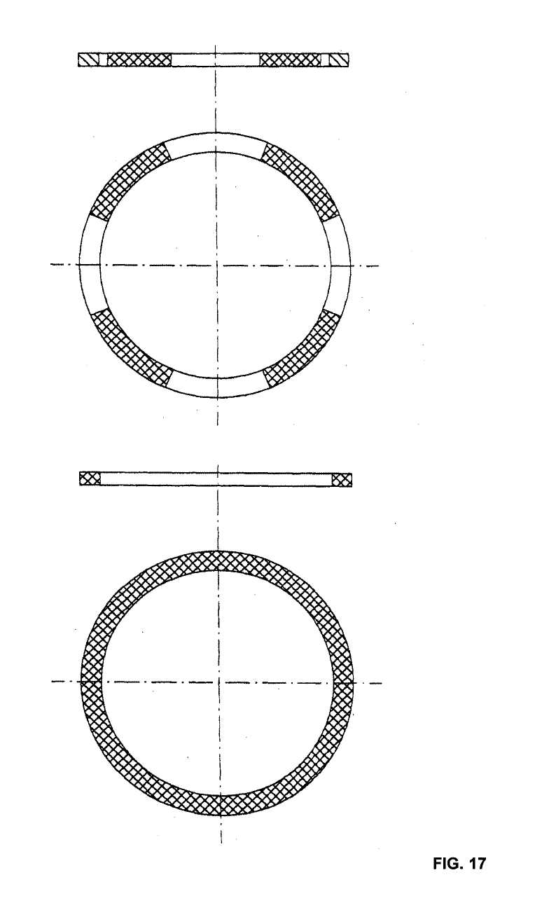

FIGS. 14 to 17 show single- or multi-layer sealing or stopper elements (not described in detail) having various designs. The sealing or stopper elements according to FIGS. 14 to 17 were produced from primary products according to FIGS. 1 to 8.

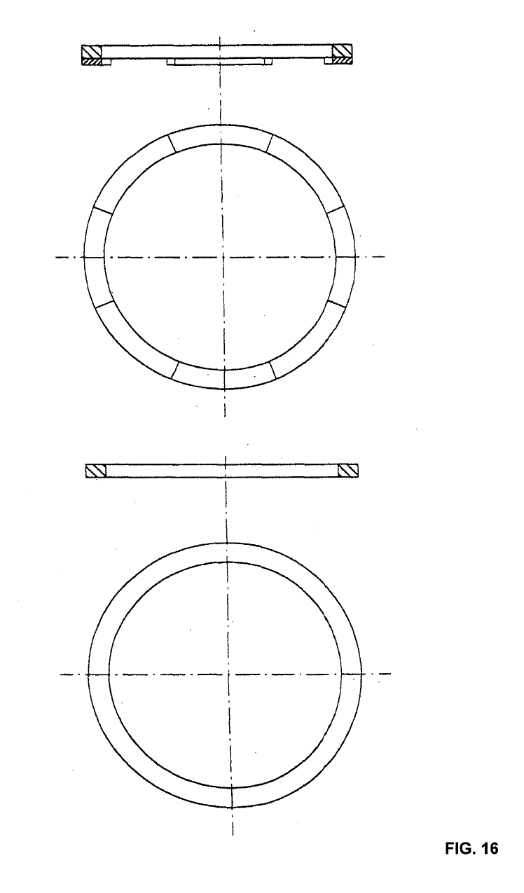

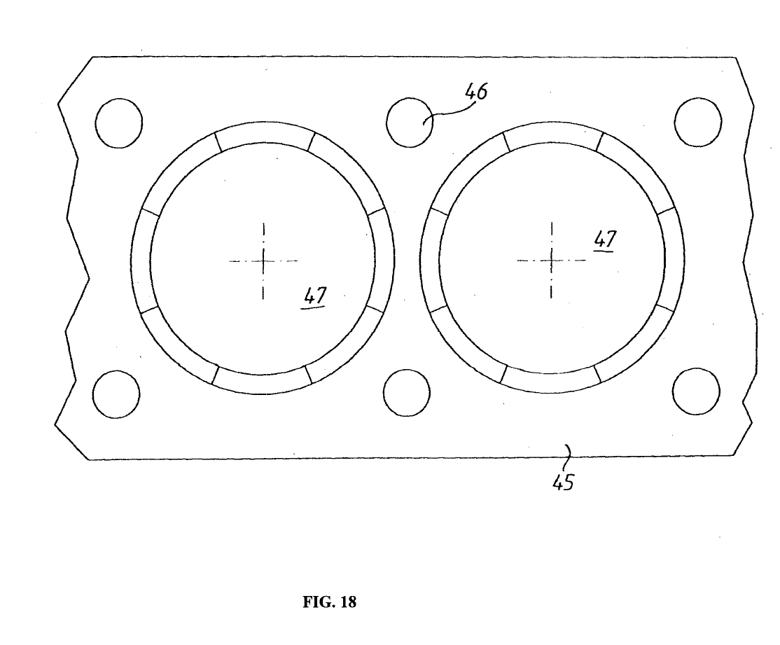

FIG. 18 shows a schematic diagram of a cylinder head gasket 45. Screw through-holes 46 and combustion chamber through-passages 47 are apparent. A sealing or stopper element as shown in FIG. 16 is inserted in the region of the combustion chamber through-passages 47.

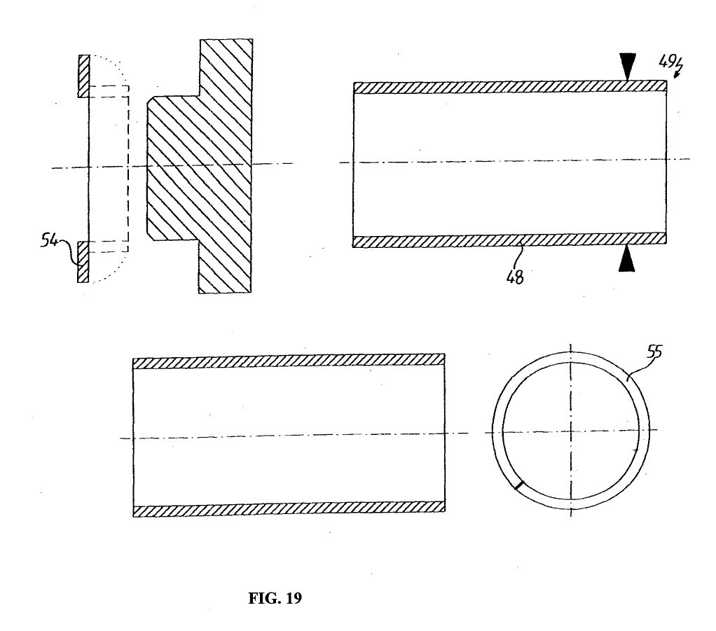

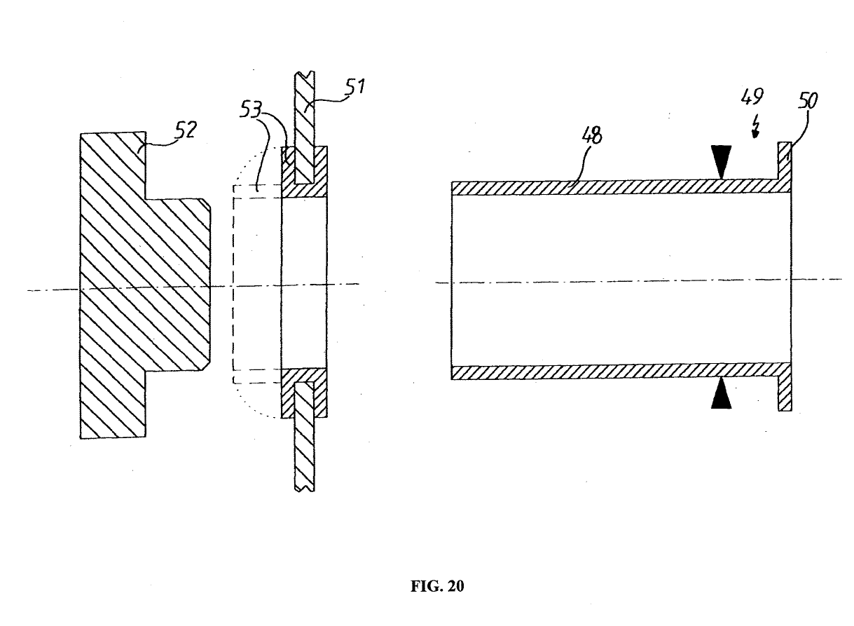

FIGS. 19 and 20 show alternative methods for producing sealing or stopper elements. In both instances, tube sections 49 are cut from a tube 48. The tube 48 according to FIG. 20 was previously provided with a radial shoulder 50. The layer 51 of a cylinder head gasket, which is not shown in detail, is brought into operative connection with the shoulder 50, and the remaining region 53 of the tube section 49 is formed in the direction of the layer 51 by means of a die 52.

The tube section 49 according to FIG. 19 is flanged in a similar manner and severed, whereby a disk-shaped sealing or stopper element 54 is obtained. The same can be further worked as needed by means of a press. If the tube 48 is only to be cut open, individual annular sealing or stopper elements 55 are obtained.

1. A method for producing metallic stopper elements for flat gaskets, comprising winding or rolling a base body comprising at least one metal sheet or foil to obtain a tube, operatively connecting mutually opposed or overlapping ends or end regions of the wound or rolled base body, contouring at least a region of the tube or a tube section produced therefrom and severing from a contoured region of the tube or tube section at least one annular or disk-shaped component comprising a stopper element for flat gaskets.

2. A method for producing metallic stopper elements for flat gaskets, comprising winding or rolling a base body comprising a contoured sheet metal strip or foil strip to obtain a tube, operatively connecting mutually opposed or overlapping ends or end regions of the tube, and severing from a contoured region of the tube or a tube section produced therefrom at least one annular or disk-shaped component comprising a stopper element for flat gaskets.

3. The method according to claim 1, wherein the base body comprises a plurality of sheet metal strips or foil strips disposed next to and/or on top of each other.

4. The method according to claim 1, further comprising, before said winding or rolling, producing expanded regions in the base body by incising regions in the base body and expanding the base body.

5. The method according to claim 1, wherein the base body is comprised of expanded and unexpanded sections.

6. The method according to claim 1 or 2, wherein the base body comprises at least one region of thickness different from that of at least one other region.

7. The method according to claim 1 or 2, further comprising producing the base body by operatively connecting a plurality of sheet metal strips or foil strips.

8. The method according to claim 1 or 2, wherein said operatively connecting is by welding.

9. The method according to claim 1 or 2, further comprising performing a forming operation on an end region of the tube so that the thereby formed end region of the tube has an L-shaped axial cross-section.

10. The method according to claim 1, wherein a leg of the L-shaped cross-section extends radially of the tube and the method further comprises cutting a disk-shaped stopper element for flat gaskets from said end region.

11. The method according to claim 1, wherein the tube contoured along its entire length prior to severing thereof into a plurality of annular components each comprising a respective stopper element for flat gaskets.

12. The method according to claim 1 or 2, wherein the severing comprises die-cutting.

13. The method according to claim 1 or 2, further comprising embossing the disk-shaped or annular stopper component thereby to provide the stopper element with predetermined surface properties.

14. (canceled)
